(19) United States
(12) Patent Application Publication
(10) Pub. No.: US 2008/0015796 A1
(43) Pub. Date: Jan. 17, 2008

(54) Piston-cylinder unit with diagnostic unit

(75) Inventors: Franz-Josef Dlugosch, Urbar (DE); Hans-Josef Hosan, Neuwied (DE); Arnold Schilz, Lahnstein (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/825,287

(22) Filed: Jul. 5, 2007

(30) Foreign Application Priority Data
Jul. 5, 2006 (DE) 10 2006 030 929.4

(51) Int. Cl. G06F 19/00; G06G 7/70

(52) U.S. Cl. 702/34; 701/115

(57) ABSTRACT

A piston-cylinder unit having a hollow cylinder, with a piston system supported inside the hollow cylinder that is free to move in the axial direction, and a piston rod connected to the piston system. The piston-cylinder unit is also provided with a diagnostic unit for determining diagnostic data associated with the piston-cylinder unit.

### BACKGROUND OF THE INVENTION

1. Field of the Invention

The present invention generally relates to the field of piston cylinders, and more particularly, to a piston-cylinder unit having a hollow cylinder that is provided with a diagnostic unit, where a piston system that is free to move in the axial direction is supported inside the hollow cylinder, and a piston rod is connected to the piston system.

2. Description of the Related Art

In general, piston-cylinder units are known. Moreover, diagnostic devices are generally known. U.S. Patent Application Publication 2003/0125841 to Schlossor discloses a diagnostic device that is used to monitor a fluidic device and/or a maintenance unit. According to Schlossor, the diagnostic device is preferable located at or on the fluidic device. The diagnostic device provides a way to ascertain at least one wear parameter causing wear on the fluidic device and to report the wear status prior to a malfunction or total failure of the fluidic device. Another diagnostic system is disclosed in U.S. Patent Application Publication 2005/0087235 to Skorpik, where the system, comprises, inter alia, a plurality of RFID sensor assemblies coupled to a valve to monitor a plurality of parameters associated with the valve.

### SUMMARY OF THE INVENTION

The present invention is directed to providing an improved piston-cylinder unit in which it is easier to identify and diagnose problems within the piston, as well as a diagnostic procedure for the piston-cylinder unit. In accordance with the invention, a piston-cylinder unit having a hollow cylinder is provided with a diagnostic unit, with a piston system supported inside the hollow the cylinder that is free to move in the axial direction, and with a piston rod connected to the piston system. The diagnostic unit is advantageously configured to determine, store and/or transmit diagnostic data. Upon determination and/or storage of the diagnostic data, it is advantageously possible to transmit the data to an external diagnostic device. In order to permit transmittal of the data, the piston-cylinder unit can be provided with a diagnostic interface.

In a preferred exemplary embodiment of the piston-cylinder unit, the diagnostic unit includes a memory device for storing data. As a result, stored data can be recalled at a later point in time by means of, for example, the diagnostic device that is connected to the diagnostic unit. It is advantageous that different sets of data pertaining to the piston-cylinder unit can thus be stored and called up again at a later time.

In another preferred exemplary embodiment of the piston-cylinder unit, the diagnostic unit is provided with a transmission device for transmitting the data between the diagnostic unit and an external diagnostic device. Here data, such as data being stored in the memory device, can be transmitted by the transmission device to the diagnostic device. Alternatively, it is possible to use the transmission device to supply the diagnostic unit with input to, for example, program the unit.

In yet another preferred exemplary embodiment of the piston-cylinder unit, the diagnostic unit includes a measuring device for measuring and/or evaluating the data. In accordance with the present contemplated embodiment, the measuring device can be used to acquire data that, for example, can be stored temporarily in the memory device or transmitted immediately to the external diagnostic device by the transmission device.

In an additional preferred exemplary embodiment of the inventive piston-cylinder unit, the memory device is provided with a memory chip (e.g., RAM, Random-Access Memory), a ROM (Read-Only-Memory), an EPROM (Erasable-Programmable Read-Only Memory) and/or flash memory (flash-EEPROM, Electrically Erasable Programmable Read-Only Memory). The skilled person will readily appreciate that memory chips having very small dimensions are available and can, therefore, be installed in a favorable location in any desired component of the piston-cylinder unit without impairing the unit's function. Moreover, it is readily understood that data can also be written very easily to memory chips, reread and erased.

In another preferred exemplary embodiment of the piston-cylinder unit, the transmission device is provided with a radio link, an inductive radio link, a Radio Frequency Identification (RFID) link, a mono-directional or a bi-directional radio link, an encoded radio link, or a set of contacts and/or a plug-in connection. As a result, the connection between the diagnostic unit and the external diagnostic device can be easily established. In accordance with the contemplated embodiment, the data can be encrypted, and/or data can be encrypted via an encrypted radio link to thereby protect the data present in the diagnostic unit, i.e., protect the data from access by unauthorized persons during transmission.

Another further preferred exemplary embodiment of the piston-cylinder unit includes a measuring device that has at least one measurement sensor. Here, the measurement sensor can be configured to determine at least one state variable of the piston-cylinder unit. In accordance with the contemplated embodiment, the state variable provides information on the current status of the piston-cylinder unit, such as the internal pressure of the unit. In alternative embodiments, the measurement sensor is configured to advantageously convert the state variables into individual data values. As a result, it becomes possible to determine the state of the piston-cylinder unit by means of the measurement sensor and to keep this information available as individual data values. In particular, each data value is maintained in the memory device of the diagnostic unit.

In accordance with the preferred exemplary embodiments of the piston-cylinder unit, the data comprise a plurality of individual data with at least one element selected from a group including: product data of the piston-cylinder unit; at least one part number; production-relevant data; at least one length of the piston-cylinder unit; at least one diameter the piston-cylinder unit; force (F1) set points; extension speed (ASG) set points; construction material data; information on the grade of installed plastic; information on the grade of oil present; information on the type of paint used; production data; factory order information; at least one serial number of the unit; at least one production date of the unit; at least one extension speed (ASG) test value; at least one extension force (ASK) test value; at least one friction test value; telemetry data; at least one current device temperature; at least one current internal pressure; information on the history of the piston-cylinder unit; at least one minimum and one maximum temperature reached in the past; at least one total number of actuated strokes; at least one number indicating hours of operation in the operating vehicle and at least one record of unusual events, e.g., violent impacts on the piston-cylinder unit. As a result of storing the foregoing data, it becomes possible to advantageously store such a wide variety of different types of information related to the piston-cylinder unit in the diagnostic unit and to recall this information at a later point in time or even while recently stored to evaluate it.

In another preferred exemplary embodiment of the piston-cylinder, the diagnostic unit is located on, mounted on or carried by the piston rod, the hollow cylinder, the connecting element and/or a sealing and guidance package of the piston-cylinder unit. Such placement of the diagnostic unit permits advantageous integration of the diagnostic unit as a miniaturized component into the piston-cylinder unit.

In accordance with the diagnostic procedure that is implemented for the above described inventive piston-cylinder unit, data are transmitted between the piston-cylinder unit and the diagnostic device. As a result, for example, the information pertaining to the piston-cylinder unit can be advantageously sent to the diagnostic device and processed, for example, in that device. In addition, it is also possible to store data from the diagnostic device in the diagnostic unit of the piston-cylinder unit for subsequent use in identifying the piston-cylinder unit.

In a preferred exemplary embodiment of the procedure, the external diagnostic device is connected to the diagnostic unit by way of a radio link, a bidirectional radio link, a mono-directional radio link, a contact-less inductive radio link, a set of contacts and/or a plug-in connection. As a result, the necessary connection for transmission of the data between the diagnostic unit and the diagnostic device can be easily established.

Another preferred embodiment of the procedure provides for the read-out of data from the measuring device and/or the memory device, where data are written to the memory device and/or erased from the memory device. As a result, the diagnostic unit becomes advantageously capable of providing flexible use for the storage and/or processing of the data.

In an additional preferred embodiment of the procedure, a plurality of individual data is transmitted, where the individual data contain at least one element of selected from a group including: product data of the piston-cylinder unit; at least one part number; production-relevant data; at least one length of the piston-cylinder unit; at least one diameter of the piston-cylinder unit; force (F1) set points; extension speed (ASG) set points; construction material data; information on the grade of installed plastic; information on the grade of oil present; information on the type of paint used; production data; factory order information; at least one serial number; at least one production date; at least one extension (ASG) test value; at least one extension force (ASK) test value; at least one friction test value; telemetry data; at least one current device temperature; at least one current internal pressure; information on the history of the piston-cylinder unit; at least one minimum and one maximum temperature reached in the past; at least one total number of actuated strokes; at least one number indicating hours of operation in the operating vehicle and at least one record of unusual events, e.g., violent impacts on the piston-cylinder unit. As a result, a wide variety of different types of data related to the piston-cylinder unit can be transmitted to provide better identification of, for example, the unit during production, and to obtain more accurate information on the current state of the piston-cylinder unit, monitor production more effectively, call up the history of the piston-cylinder unit and/or to reconfigure or adapt the piston-cylinder unit during operation to conditions under which the piston-cylinder unit is being used.

Another preferred embodiment of the procedure provides for the read out of data, in particular telemetry data, during the operation of the piston-cylinder unit. Here, the data can advantageously be sent to a controller system for comparison with predefined set points to adapt the piston-cylinder unit during operation through negative feedback.

In yet another preferred embodiment of the procedure, characteristic values of the piston-cylinder unit are adapted to the operational conditions of the piston-cylinder unit. Here, the set points of the characteristic values are determined based on, for example, the transmitted data. As a result, it becomes possible to calculate favorable characteristics from the current operating state of the piston-cylinder unit and to adjust the piston-cylinder unit to the new set points thus obtained. As a result, it becomes possible to achieve a piston-cylinder unit that adapts itself to the operating conditions, i.e., a self adapting piston-cylinder unit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings, where identical, similar, and/or functionally equivalent parts are designated by the same reference numbers, and in which:

FIG. 1 is of a longitudinal cross sectional view through part of a piston-cylinder unit with a guide and sealing package, which carries a contactable diagnostic unit according to an embodiment of the present invention;

FIG. 2 is a longitudinal sectional view of an alternative embodiment of the piston-cylinder unit of FIG. 1, but with a diagnostic unit which can be accessed in a contact-less manner;

FIG. 3 is a partial sectional view of an alternative embodiment of a piston-cylinder unit with a piston rod, which carries a contactable diagnostic unit;

FIG. 4 is a sectional view of an alternative embodiment of the piston-cylinder unit of FIG. 3, but with a diagnostic unit which can be accessed in a contact-less manner;

FIG. 5 is a partial sectional view of an alternative embodiment of a piston-cylinder unit with a top end, which carries a contactable diagnostic unit;

FIG. 6 is a partial sectional view of an alternative embodiment of the piston-cylinder unit of FIG. 5, but with a diagnostic unit which can be accessed in a contact-less manner;

FIG. 7 is a partial sectional view of an alternative embodiment of the piston-cylinder unit of FIG. 2, where the diagnostic unit has a radio unit recessed into a wall of the hollow cylinder of the piston-cylinder unit;

FIG. 8 is a partial sectional view of an alternative embodiment of the piston-cylinder unit of FIG. 7, where the diagnostic unit has a radio unit located outside of the wall of the hollow cylinder of the piston-cylinder unit; and

FIG. 9 is a partial sectional view of an alternative embodiment of the piston-cylinder unit of FIG. 2, where the diagnostic unit has a radio unit and a measuring device that are integrated into a single component.

### DETAILED DESCRIPTION OF THE EXEMPLARY EMBODIMENTS

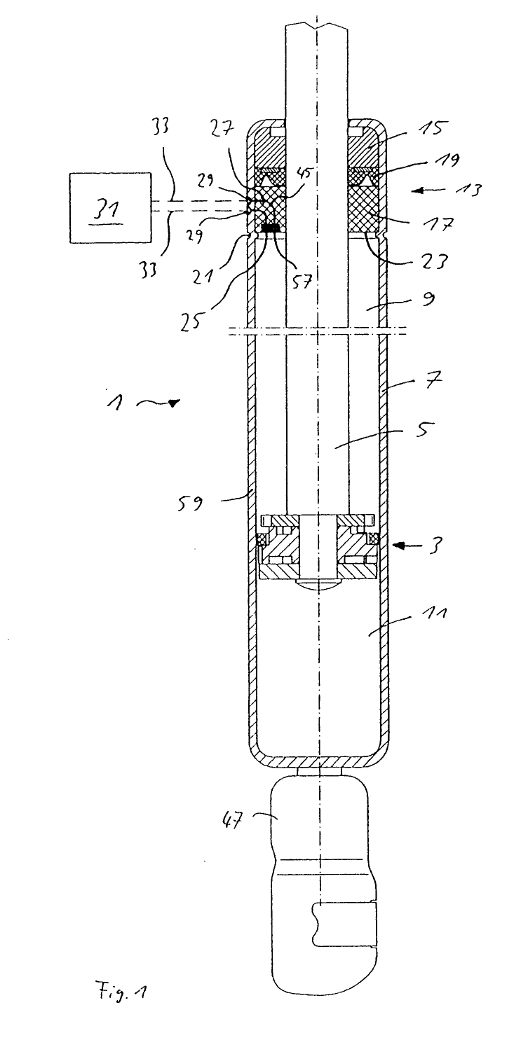

FIG. 1 is an illustration of a piston-cylinder 1 with a piston system 3. The piston system 3 is permanently connected to the piston rod. 5. The piston system 3 is also mounted inside the hollow cylinder 7, where the piston system 3 is free to move in the axial direction and the piston system 3 divides the hollow cylinder 7 into a first working space 9 and a second working space 11. The piston rod 5 projects out of the first working space 9 and is supported by a guide and sealing package 13, in which it is free to slide back and forth in the axial direction. The guide and sealing package 13 provides a way to seal off the first working space 9 of the piston-cylinder 1 in a fluid-tight manner against the environment. The guide and sealing package 13 has an upper guide ring 15, a lower guide ring 17, and a sealing ring 19 disposed between the upper guide ring 15 and the lower guide ring 17. A circumferential groove 21 in the hollow cylinder 7 of the piston-cylinder 1 acts as a stop for the lower guide ring 17.

The end surface 23 of the lower guide ring 17 is in contact with fluid located in the working space 9, such as a pressurized gas. A diagnostic unit 25 is recessed into the end surface 23 of the lower guide ring 17. This diagnostic unit 25 can have, for example, a memory unit such as a chip and a measuring device for evaluating data characterizing the state of the piston-cylinder unit 1. The entire functionality of the diagnostic unit can be integrated into one chip, which comprises a measuring device, a memory device, and/or a transmission device. In accordance with the invention, the measuring device is configured to measure, for example, the pressure of the fluid and to then send the measured value to the memory unit.

The diagnostic unit 25 includes a transmission device 27 with contacts 29 shown by way of example in FIG. 1. The transmission device 27 and the contacts 29 can be used to connect an external diagnostic device 31, such as a reading or programming unit, to the diagnostic unit 25 of the piston-cylinder unit 1. As a result, it becomes possible to transmit data between the external diagnostic device 31 and the diagnostic unit 25. In accordance with the invention, the data can be transmitted over signal lines, for example, which are indicated in FIG. 1 by the broken lines 33. In alternative embodiments, the contacts 29 can be configured as a plug-in device that can be accessed by the diagnostic device 31.

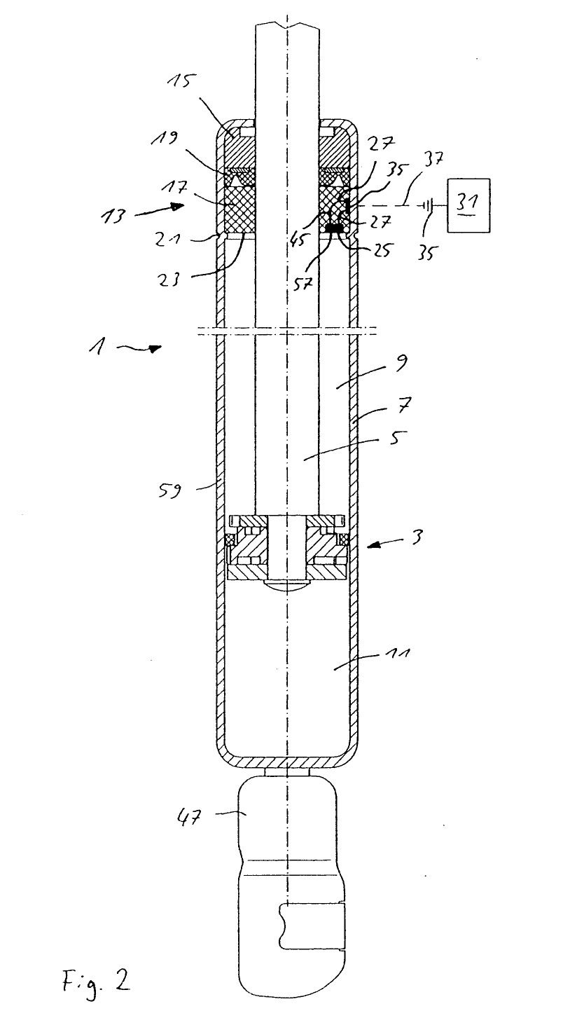

FIG. 2 is an illustration of an alternative embodiment of the piston-cylinder unit 1 of FIG. 1. Here, the transmission device 27 and the external diagnostic device 31 each have a radio unit 35 that is used to establish a radio link. The radio link between the two radio units 35 is indicated by a broken line 37. In accordance with the contemplated embodiment, the radio unit 35 can be a conventional transceiver, such as an inductive transceiver, in which case the radio unit 35 of the transmission device 27 does not require its own power supply. In addition, the data can be transmitted by means of Radio Frequency Identification (RFID) technology.

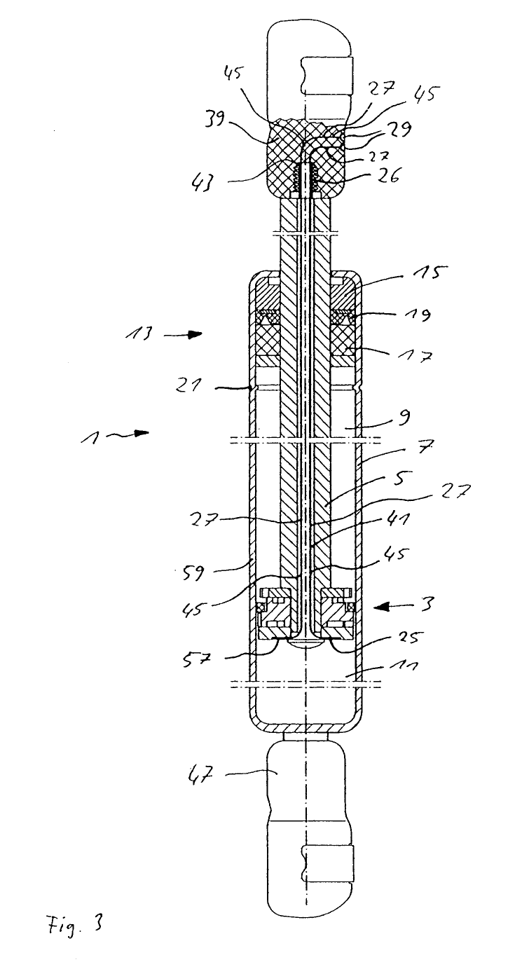

FIG. 3 is an illustration of another embodiment of the piston-cylinder unit in accordance with the invention. In contrast to the piston-cylinder unit of the embodiments illustrated in FIGS. 1 and 2, the diagnostic unit 25 of the present embodiment is carried by or mounted on the piston system 3 of the piston-cylinder unit 1. Here, the piston system 3 is permanently connected to the piston rod 5 and forms the working spaces 9 and 11.

Alternatively, the diagnostic unit 25 of the piston-cylinder unit 1 illustrated in FIG. 3 can also be used to determine the prevailing pressure in the piston-cylinder unit 1. With specific reference to FIG. 3, the diagnostic unit 25 is shown located adjacent to a bore 41. The diagnostic unit 25 is located inside the piston system 3. As a result, this requires the lines 45 of the transmission devices 27 to be passed through bores 41 and 43. In addition, the diagnostic unit 25 is recessed into a ring of the piston system 3 that is located adjacent to the second working space 11. Alternatively, it is possible to locate the diagnostic unit 25 on the piston system 3 such that the pressures of both the first working space 9 and of the second working space 11 can be measured. In addition to measuring the prevailing pressures in the working spaces 9, 11, however, it is also contemplated that any other desired state variables, such as the temperature, can also be measured. With additional reference to FIG. 3, the piston-cylinder unit 1 also includes a connecting element 39, which is permanently connected to the piston rod 5, and serves to connect the piston-cylinder 1 to another component, such as the chassis of a motor vehicle.

In other contemplated embodiments, it is possible to install the diagnostic unit 25 at some other point or location, such as in one of the bores 41, 43, i.e., in the piston rod itself. In other alternative embodiments, the diagnostic unit 25 is installed in the area of the interface between the piston rod 5 and the connecting element 39. In addition, it is also contemplated that the pressure in the second working space 11 could be transferred by way of a bore 41 introduced into the piston rod 5, where the bore 41 would lead out into a bore 43 in the connecting element 39 for just such a purpose. In accordance with the present contemplated embodiments, the bore 43 is provided with a thread 26 to accept a component such as a connector part. The thread 26 can be formed as a self-cutting thread, i.e. the thread will cut its own thread when the connector part is screwed in. It is also contemplated that it is possible to integrate the diagnostic unit 25 into the connecting element 39, such as into the connector part so as to house the diagnostic unit 25 in the bore 43.

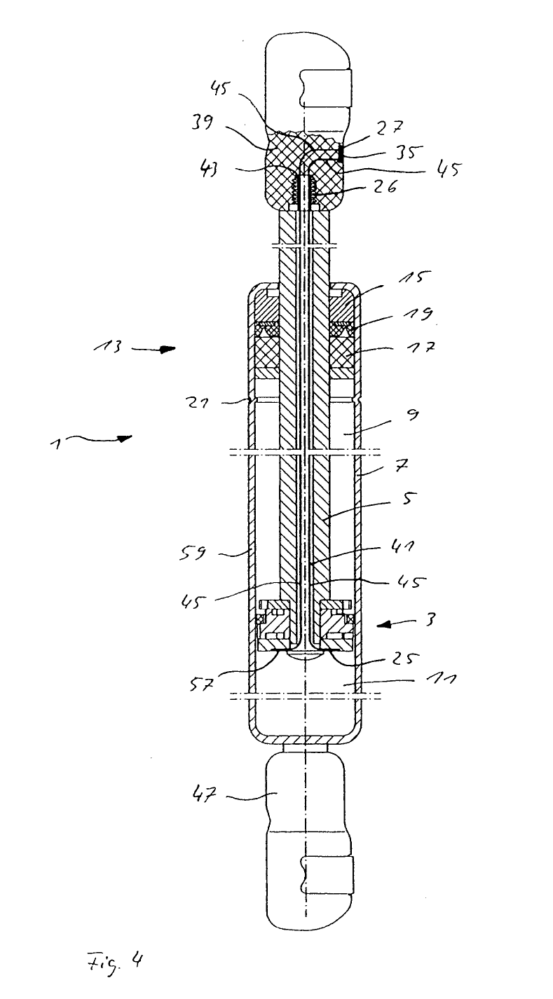

FIG. 4 is an illustration of an alternative embodiment of the piston-cylinder unit of FIG. 3. In contrast to the embodiment of the piston-cylinder unit illustrated in FIG. 3, however, the piston-cylinder unit 1 in accordance with the present contemplated embodiment is provided with a radio unit 35 that is similar to the radio unit 35 described in conjunction with the embodiment of the piston-cylinder unit described with respect to FIG. 2.

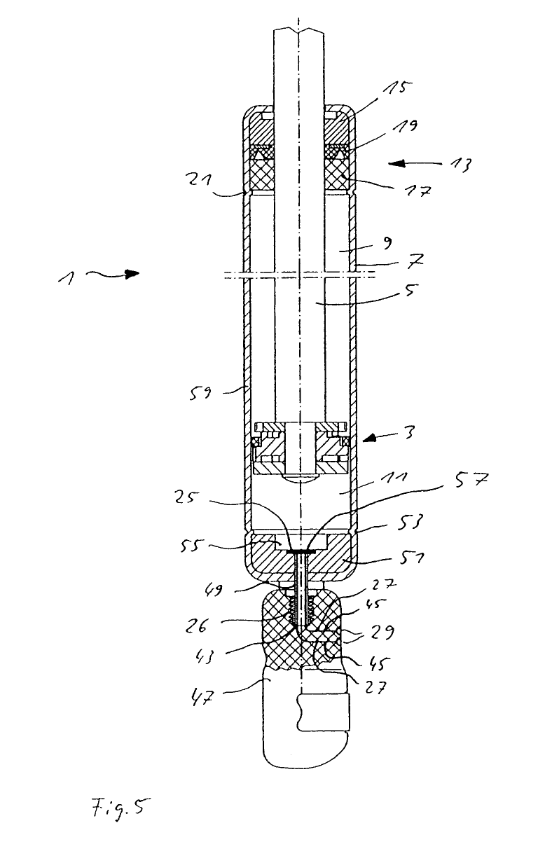

FIG. 5 is an illustration of an embodiment of the piston-cylinder unit 1, in which, similarly to the piston-cylinder unit of FIG. 3, the diagnostic unit 25 is installed directly at the boundary of the working space 11 and can be accessed by way of lines 45 that are passed through a lower connecting element 47. Here, the lower connecting element 47 also has a bore 43. As shown in FIG. 5, however, the bore 43 of the present contemplated embodiment passes through a sleeve 49, which connects the lower connecting element 47 and the hollow cylinder 7 of the piston-cylinder unit 1 to each other. The sleeve 49 is connected to the connecting element 47 by a thread 26 and passes through an end ring 51 located at the end inside the working space 11. The end ring 51 is held in place in the hollow cylinder 7 by a groove 53 in the hollow cylinder 7. This end ring 51 can serve as an end stop for the piston system 3. Such a stop is achieved by providing a ring 51 that comprises a springy and elastic material. The end ring 51 is provided with a recess 55. In accordance with the contemplated embodiment, the diagnostic unit 25 is mounted in this recess 55 so that it is directly adjacent to the second working space 11. In particular, the measuring device 57 can also be mounted in the recess 55 in the end ring 51. In preferred embodiments, the measuring device 57 can be, for example, a piezoelectric pressure sensor. It is also conceivable, however, that the prevailing pressure inside the working space 11 could be transmitted via the bore 43 in the sleeve 49, so that the measuring device 57 of the diagnostic unit 25 could be installed inside the lower connecting element 47.

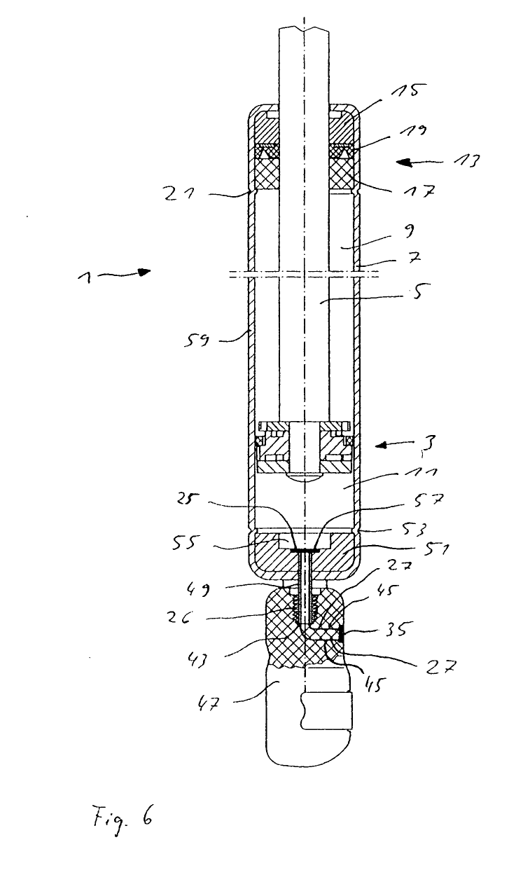

FIG. 6 is an illustration of an alternative embodiment of the piston-cylinder unit 1 of FIG. 5. In contrast, however, the diagnostic unit 25 of the present contemplated embodiment has a radio unit 35 that is similar to the radio unit 35 described in conjunction with the embodiment of the piston-cylinder unit 1 described with respect to FIG. 2.

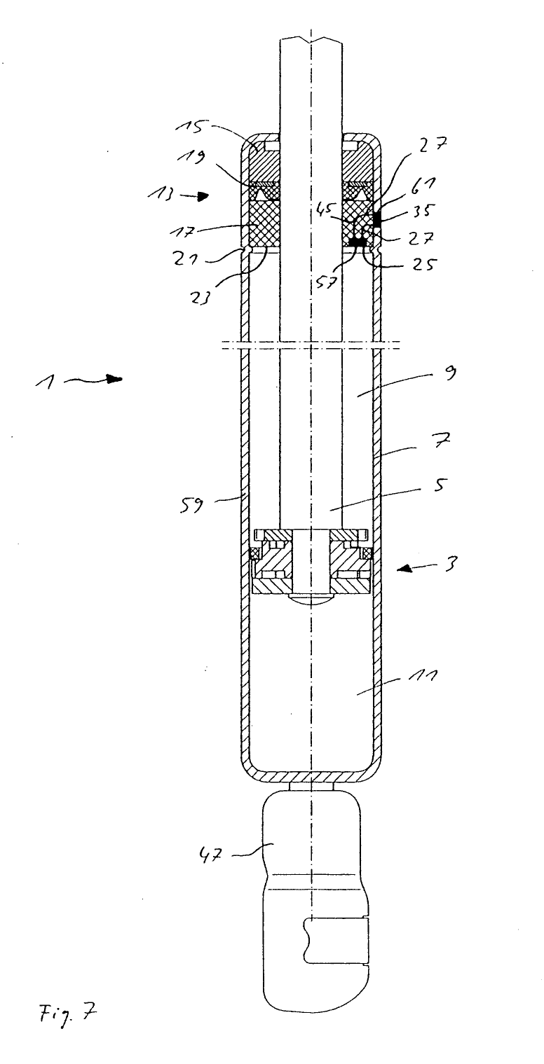

FIG. 7 is an illustration of an alternative embodiment of the piston-cylinder unit of FIG. 2, where the diagnostic unit 25 has a radio unit 35 recessed into a wall 59 of the hollow cylinder 7 of the piston-cylinder unit. As shown in FIG. 7, the wall has a through-bore 61 for just this purpose, into which the radio unit 35 is inserted in a pressure-tight manner. In accordance with the present embodiment, the radio unit 35 and/or the through-bore 61 can be provided with a suitable seal or a suitable sealable material. In addition, the radio unit 35 can be held in place in the through-bore 61 in any suitable manner by the use of a joining technique such as press-fitting, welding, adhesive bonding, etc. As a result, it becomes possible to establish a more effective radio link with an external diagnostic device 31 (see FIG. 2), especially when the wall 59 is thick.

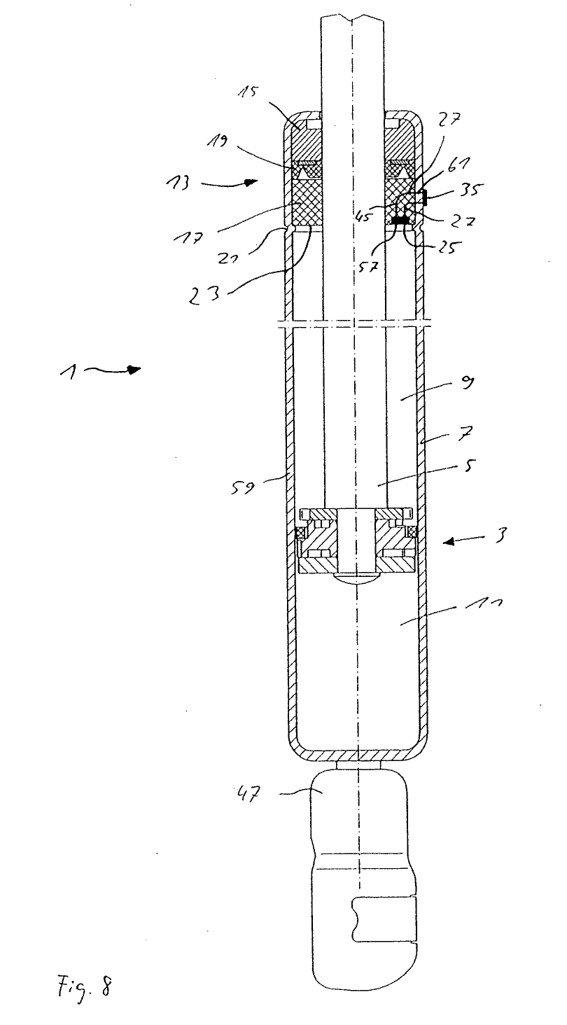

FIG. 8 is an illustration of an alternative embodiment of the piston-cylinder unit of FIG. 7, where the diagnostic unit 25 additionally includes a radio unit 35 that is installed outside the wall 59 of the hollow cylinder 7 of the piston-cylinder unit 1. Here, lines 45 are passed through the wall 59 of the hollow cylinder 7 to connect the remainder of the diagnostic unit 25 to the radio unit 35. In order to permit the lines to pass through the wall 59, at least one or two through-bores similar to the through-bore 61, are provided in the wall 59, but with reduced diameters that are adapted to correspond to the lines 45. As in the previously described embodiments, the lines 45 are passed through the wall 59 in a pressure-tight manner, and the wall 59 and/or the lines are provided with an appropriate seal.

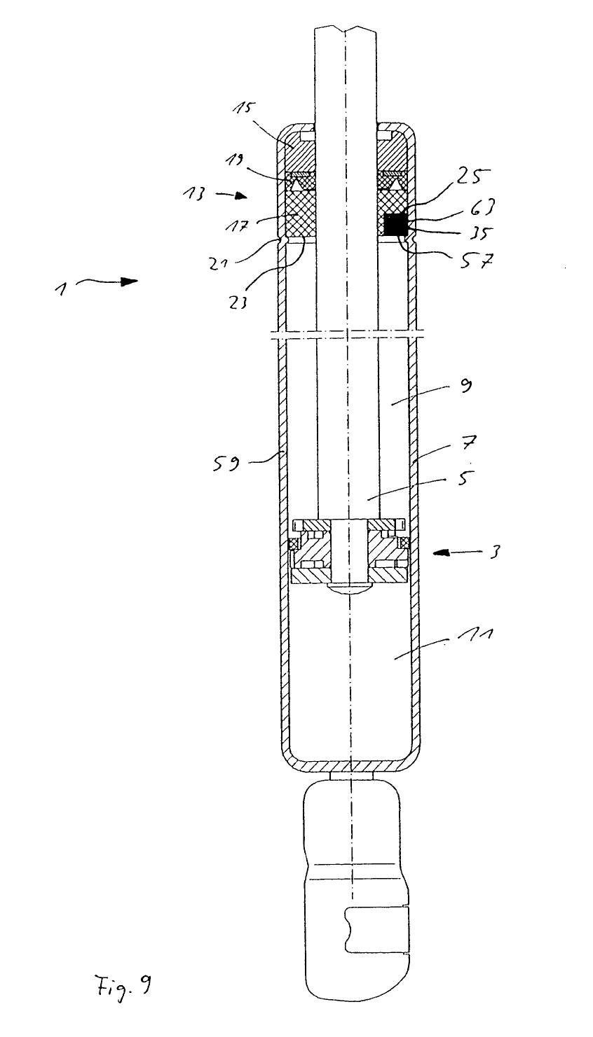

FIG. 9 is an illustration of an alternative embodiment of the piston-cylinder unit of FIG. 2, where the diagnostic unit 25 includes a radio unit 35 and a measuring device 57 that are integrated into a single component. As a result, it becomes possible to integrate all of the functionalities of the diagnostic unit 25 in one component 63, such as a chip. Therefore, the need for additional components such as contacts and/or lines is eliminated. In accordance with the contemplated embodiment, the component 63 is mounted in the end surface 23 of the lower guide ring 17, directly adjacent to the working space 11 of the piston-cylinder unit 1. It is contemplated that the component 63 can be mounted in other positions inside the piston-cylinder unit 1, however, such as in an end ring similar to the end ring 51 of FIG. 5 or inside the piston system itself. As a result, the need for any cables or contacts is advantageously eliminated. Here, it is sufficient to merely attach it to the rest of the piston-cylinder unit 1 to install the component 63.

In alternative contemplated embodiments of the invention, the piston-cylinder unit 1 illustrated in FIGS. 1-6 is advantageously provided with a memory chip or a functional unit, such as a measuring device 57 based on piezoelectricity. In alternative embodiments, such a type of chip or memory device is introduced and placed in a pressure space located between the piston rod 5 and a nozzle bush.

It can be advantageous to introduce the memory device of the diagnostic unit 25 as early as possible during the assembly of the piston-cylinder unit 1. In fact, the guide and sealing package 13 is especially suited for just this purpose. In accordance with the contemplated embodiments of the invention, the diagnostic unit 25 makes it possible to continuously measure the prevailing pressure in the hollow cylinder 7. In addition, the temperature can be measured continuously or at individual moments in time. Moreover, the present inventors also contemplate that a history of the part could be stored in the memory device of the piston-cylinder unit 1. This history could provide information on, for example, the characteristic curve of the prevailing pressure over time, which provides information on the piston-cylinder unit 1 as it ages. It is also possible to compare various sets of measurement data with a theoretically calculated pressure or force curve. Here, data of the part history could be structured such that it could also contain the total number of load cycles on the piston-cylinder unit 1.

In accordance with the contemplated embodiments, the diagnostic unit 25 can be configured such that it has an optimum electromagnetic compatibility (EMC). In particular, the diagnostic unit 25 is configured such that no data can be lost due to influences emanating from other devices. In addition, the diagnostic unit 25 is configured such that it cannot and does not influence any other devices located in close proximity or nearby.

In addition, it is also possible to provide the diagnostic unit 25 with telemetry capability, so that, for example, readers installed in the production equipment for the piston-cylinder unit 1 can perform quality assurance procedures. Thus, a plurality of piston-cylinder units 1 could be checked while they are enclosed in a completely closed package. For example, the package unit could be checked for quantity and for the correctness of the individual parts. Moreover, the production data necessary for the continuous documentation of safety-relevant parts, for example, could be stored directly in the diagnostic unit 25 of the piston-cylinder unit 1.

In order to preserve confidentiality, in accordance with other contemplated embodiments, data internal to production could be erased from the diagnostic unit 25, especially at the end of the production process. Here, a write unit (not shown) of the diagnostic unit 25 is provided with a delete function to ensure complete erasure of the production specific data.

In other embodiments, the diagnostic device 31 is equipped with a signal lamp having the colors red and green, which displays either red for “not OK” or green for “OK” when a packaged item is being checked for certain characteristics, labeling, quantities, and the like.

In further additional embodiments of the invention, several different versions of the diagnostic device 31 is provided. For example, in one embodiment the diagnostic device 31 is configured such that only data that a customer is allowed to see can be read out from the device. Correspondingly, in another embodiment, the diagnostic device 31 is configured to allow all of the stored data to be read out. Pursuant to achieving the present contemplated embodiments, the diagnostic unit 25 of the piston-cylinder unit 1 is encoded in an appropriate manner.

The service life of the diagnostic unit 25 of the disclosed embodiments can be adapted to the service life of the piston-cylinder unit 1. As a result, the diagnostic unit 25 will always be able to function error-free until the end of the life of the piston-cylinder unit 1. Adaptation of the service life of the diagnostic unit 25 to the service life of the piston-cylinder unit 1 permits the taking into account of special circumstances, such as the harsh environment inside an engine compartment.

In other embodiments, the diagnostic unit 25 is configured such that it can easily survive the conventionally manufacturing steps used to produce the piston-cylinder unit 1, such as painting, powder-coating, and wrapping with heat-shrink film. Alternative embodiments of the diagnostic unit 25 are configured such that any incompatibility with the oils and greases used in the piston-cylinder unit 1 are excluded.

The present inventors have conceived embodiments of the diagnostic unit 25 that can generate a fingerprint at each workplace and store this fingerprint in an appropriate manner. As a result, it becomes possible to trace the entire process, with the help of the diagnostic unit 25, used to make the piston-cylinder unit 1, all the way back to the individual workplace or to the employee working at the specific workplace. Moreover, due to the advantages associated with the ability to track and locate specific components that are dispersed in the field, there are embodiments of the present invention in which a GPRS transmitter (General Packet Radio Service) is introduced into the piston-cylinder unit 1.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A piston-cylinder unit comprising:
a hollow cylinder;
a piston system supported inside the hollow cylinder, said piston system being free to move in an axial direction;
a piston rod connected to the piston system; and
a diagnostic unit disposed within the piston cylinder, said diagnostic unit determining data related to the piston-cylinder unit.

2. The piston-cylinder unit according to claim 1, wherein the diagnostic unit includes a memory device for storing the data.

3. The piston-cylinder unit according to claim 1, wherein the diagnostic unit includes a transmission device for transmitting the data between the diagnostic unit and an external diagnostic device.

4. The piston-cylinder unit according to claim 1, wherein the diagnostic unit includes a measuring device for at least one of measuring and evaluating data.

5. The piston-cylinder unit according to claim 2, wherein the memory device includes at least one of a chip, a memory chip (RAM), flash memory (EEPROM), a ROM and an EPROM.

6. The piston-cylinder unit according to claim 3, wherein the transmission device includes at least one of a radio link, an inductive radio link, a mono-directional or bidirectional radio link, a plug-in connection and a set of contacts.

7. The piston-cylinder unit according to claim 4, wherein the measuring device includes at least one measurement sensor.

8. The piston-cylinder unit according to claim 1, wherein the data comprise a large number of individual data with at least one element selected from a group comprising: product data of the piston-cylinder unit; at least one part number; production-relevant data; at least one length of the piston-cylinder unit; at least one diameter piston-cylinder unit; force set points; extension speed set points; construction material data; information on the grade of installed plastic; information on a grade of oil present; information on a type of paint used; production data; factory order information; at least one serial number; at least one production date; at least one extension speed test value; at least one extension force test value; at least one friction test value; telemetry data; at least one current device temperature; at least one current internal pressure; information on a history of the piston-cylinder unit; at least one minimum and one maximum previously reached temperature; at least one total number of actuated strokes; at least one number indicating hours of operation in an operating vehicle and at least one record of unusual events.

9. The piston-cylinder unit according to claim 1, wherein the diagnostic unit is mounted on at least one of a chip, the piston rod, the hollow cylinder, a connecting element and a sealing and guide package of the piston-cylinder unit.

10. The piston-cylinder unit according to claim 7, wherein the measurement sensor is a piezoelectric pressure sensor.

11. The piston-cylinder unit according to claim 8, wherein the at least one record of unusual events comprises violent impacts on the piston-cylinder unit.

12. A diagnostic procedure for a piston-cylinder unit comprising a hollow cylinder, a piston system supported inside the hollow cylinder, said piston system being free to move in an axial direction, a piston rod connected to the piston system, and a diagnostic unit disposed within the piston cylinder, said procedure comprising:
acquiring data associated with the piston-cylinder unit at the diagnostic unit; and
transmitting the acquired data between the piston-cylinder unit and an external diagnostic device.

13. The diagnostic procedure according to claim 12, further comprising:
connecting the diagnostic unit to the diagnostic device using at least one of a radio link, a mono-directional or bidirectional radio link, a contact-less inductive radio link, a set of contacts and a plug-in connection.

14. The diagnostic procedure according to claim 12, further comprising at least one of:
reading out data from a measuring device connected to the diagnostic unit;
reading out data from a memory device within the diagnostic unit;
writing data to the memory device; and
erasing data from the memory device.

15. The diagnostic procedure according to claim 12, further comprising:
transmitting a plurality of individual data;
wherein the individual data comprise at least one element selected from the group comprising: product data of the piston-cylinder unit; at least one part number; production-relevant data; at least one length of the piston-cylinder unit; at least one diameter of the piston-cylinder unit; force set points; extension speed set points; construction material data; information on a grade of installed plastic; information on a grade of oil present; information on a type of paint used; production data; factory order information; at least one serial number; at least one production date; at least one extension speed test value; at least one extension force test value; at least one friction test value; telemetry data; at least one current device temperature; at least one current internal pressure; information on history of the piston-cylinder unit; at least one minimum and one maximum previously reached temperature; at least one total number of actuated strokes; at least one number indicating hours of operation in an operating vehicle and at least one record of unusual events.

16. The diagnostic procedure according to claim 13, further comprising:
reading out the data during operation of the piston-cylinder unit.

17. The diagnostic procedure according to claim 16, further comprising:
adapting characteristic values of the piston-cylinder unit to operational conditions of the piston-cylinder unit;
wherein determination of set points of the characteristic values is based on the data which have been read out.

18. The diagnostic procedure according to claim 13, further comprising at least one of:
reading out data from a measuring device connected to the diagnostic unit;
reading out data from a memory device within the diagnostic unit;
writing data to the memory device; and
erasing data from the memory device.

19. The diagnostic procedure according to claim 13 further comprising:
transmitting a plurality of individual data;
wherein the individual data comprise at least one element selected from the group comprising: product data of the piston-cylinder unit; at least one part number; production-relevant data; at least one length of the piston-cylinder unit; at least one diameter of the piston-cylinder unit; force set points; extension speed set points; construction material data; information on a grade of installed plastic; information on a grade of oil present; information on a type of paint used; production data; factory order information; at least one serial number; at least one production date; at least one extension speed test value; at least one extension force test value; at least one friction test value; telemetry data; at least one current device temperature; at least one current internal pressure; information on history of the piston-cylinder unit; at least one minimum and one maximum previously reached temperature; at least one total number of actuated strokes; at least one number indicating hours of operation in an operating vehicle and at least one record of unusual events.

20. The diagnostic procedure according to claim 14, further comprising:
transmitting a plurality of individual data;
wherein the individual data comprise at least one element selected from the group comprising: product data of the piston-cylinder unit; at least one part number; production-relevant data; at least one length of the piston-cylinder unit; at least one diameter of the piston-cylinder unit; force set points; extension speed set points; construction material data; information on a grade of installed plastic; information on a grade of oil present; information on a type of paint used; production data; factory order information; at least one serial number; at least one production date; at least one extension speed test value; at least one extension force test value; at least one friction test value; telemetry data; at least one current device temperature; at least one current internal pressure; information on history of the piston-cylinder unit; at least one minimum and one maximum previously reached temperature; at least one total number of actuated strokes; at least one number indicating hours of operation in an operating vehicle and at least one record of unusual events.

21. The diagnostic procedure according to claim 13, further comprising:
reading out the data during operation of the piston-cylinder unit.

22. The diagnostic procedure according to claim 14, further comprising:
reading out the data during operation of the piston-cylinder unit.

23. The diagnostic procedure according to claim 15, further comprising:
reading out the data during operation of the piston-cylinder unit.

24. The diagnostic procedure according to claim 15, wherein the at least one record of unusual events comprises violent impacts on the piston-cylinder unit.

25. The diagnostic procedure according to claim 19, wherein the at least one record of unusual events comprises violent impacts on the piston-cylinder unit.

26. The diagnostic procedure according to claim 20, wherein the at least one record of unusual events comprises violent impacts on the piston-cylinder unit.

27. The diagnostic procedure according to claim 16, wherein the data comprises telemetry data.

28. The diagnostic procedure according to claim 21, wherein the data comprises telemetry data.

29. The diagnostic procedure according to claim 22, wherein the data comprises telemetry data.

30. The diagnostic procedure according to claim 23, wherein the data comprises telemetry data.
